(19) United States
(12) Patent Application Publication
(10) Pub. No.: US 2003/0078345 A1
(43) Pub. Date: Apr. 24, 2003

(54) Process for the preparation of ion exchange membranes

(76) Inventor: Patrick John Morrisey, Uxbridge (GB)

Correspondence Address: Antonelli Terry Stout & Kraus, Suite 1800, 1300 North Seventeenth Street, Arlington, VA, 22209, US

(21) Appl. No.: 10/257,630

(22) PCT Filed: Apr. 9, 2001
(86) PCT No.: PCT/GB01/01603

(51) Int. Cl. C08F 14/18; C08C 19/24; C08C 19/20

(52) U.S. Cl. 525/326.2; 525/340; 525/343

(57) ABSTRACT

A process for manufacturing a cation-selective ion exchange membrane which comprises contacting one or both sides of a membrane comprising a polymer having side chains which contain acid groups with a solution which comprises one or more soluble salts of one or more onium ions and a salt which will prevent swelling of the membrane, for a period of time sufficient to allow the desired extent of substitution of the cations which are associated with the acid groups by onium ions.

The present invention relates to a process for the preparation of cation exchange membranes.

Cation-selective organic polymer membranes are used in a variety of applications such as electrolytic systems, electrodialysis systems, fuels cells and secondary batteries. Cation exchange membranes which are particularly useful for the devices mentioned above are fluorinated cation exchange polymers which contain pendant side chains with sulfonic acid groups (—SO₃⁻), carboxylic acid groups (—CO₂⁻) or phosphonic acid groups (—PO₃²⁻). Associated with the acid groups may be one or more of a range of cations such as H⁺, Na⁺, K⁺, Li⁺ or other alkali metals or monovalent complex cations. Such membranes are well known in the art and can be obtained as precursor polymers wherein the sulfonyl, carboxyl or phosphonyl groups are in the —SO₂X, —COX or —POX₂ form (X=F or Cl, usually F). The precursor may be converted to the ion exchange form by alkaline hydrolysis.

In order to operate such electrochemical devices efficiently it is desirable that the membrane has a high selectivity for cations and a low resistance to the passage of electrical current. High selectivity increases the current efficiency when used in secondary battery applications and reduces the contamination of process streams by undesirable by-products which may result when species other than cations pass through the membrane. High selectivity reduces cross contamination of the process streams both in fuel cells and in electrolytic systems. Low resistivity minimises the voltage drop across the membrane and results in an increase in the voltage efficiency of the device.

Unfortunately however, the selectivity and resistivity of the membrane are generally interdependent. An increase in selectivity generally results in an increase in resistivity. It would be desirable to find a way of improving the selectivity of the membrane without causing an increase in its resistivity.

A number of ways of addressing this problem have been previously identified.

U.S. Pat. No. 3,692,569 (Grot) discloses an ion-exchange copolymer with a non-uniform structure. The copolymer coating has an equivalent weight no greater than 1,150 whilst the core has an equivalent weight of at least 1,500.

U.S. Pat. No. 3,909,378 (Walmsley) also discloses an ion-exchange copolymer with a non-uniform structure. In this case, one surface of the copolymer film to a depth no more than one-third of the film's thickness contains the copolymer at an equivalent weight of at least 250 greater than the equivalent weight of the copolymer comprising the remainder of the film.

U.S. Pat. No. 3,784,399 (Grot) discloses a non-uniform ion-exchange structure wherein the ion-exchange groups differ. One surface of the film has a majority of the sulfonyl groups of the polymer in the form —(SO₂NH)ₘQ wherein Q is H, NH₄, an alkali metal cation and/or alkaline earth metal cation and m is the valence of Q. The other surface of the film has sulfonyl groups in the form —(SO₃)ₙMe wherein Me is a cation and n is the valence of the cation.

U.S. Pat. No. 4,085,071 (Resnick, et al) discloses an ion-exchange film which comprises a fluorine-containing polymer containing pendant side chains with sulfonyl groups wherein at least 40% of the sulfonyl groups in a first layer of said film are present as N-monosubstituted sulfonamido groups or salts thereof and wherein the second layer of said film has a majority of the sulfonyl groups present as —(SO₂NH)ₘQ or —(SO₃)ₙMe wherein Q is H, NH₄, alkali metal cation, alkaline earth metal cation and combinations thereof, m is the valence of Q, Me is a cation and n is the valence of the cation.

U.S. Pat. No. 4,246,091 discloses a cation exchange membrane in which sulfonic acid groups on the membrane are treated with a primary or tertiary monoamine, or a quaternary ammonium salt and the membrane is then heat treated in order to improve its selectivity.

In Polymer, volume 38, issue 6, pp1345-1356, there is described a process for chemical modification of a Nafion™ sulfonyl fluoride precursor. Diffusion-mediated reaction of 3-aminopropyltriethoxysilane with SO₂F groups forms sulfonamide linkages and condensation reactions of the SiOR groups can provide covalent crosslinking of chains.

The surface of ion-exchange membranes may also be modified by plasma processes. Journal Denki Kagaku, 1992, volume 60, issue 6, pp462-466 and J. Adhes. Sci. Technol., volume 9, issue 5, pp615-625 describes sputtering of a Nafion™ membrane with an oxygen or argon plasma to produce radical sites followed by reaction at the radical sites with 4-vinylpyridine or 3-(2-aminoethyl)aminopropyl-trimethoxysilane vapour.

U.S. Pat. No. 5,968,326 (Yelon et al) discloses a composite membrane which is fabricated by depositing an inorganic ion-conducting thin film on a cation-selective organic polymer membrane substrate using Pulse Laser Depostion (PLD) or reactive magnetron sputtering.

The present invention provides a process for preparing cation-selective ion exchange membranes which have an improved selectivity without causing significant increases in their resistivity.

Accordingly the present invention provides a process for manufacturing a cation-selective ion exchange membrane which comprises contacting one or both sides of a membrane comprising a polymer having side chains which contain acid or acid salt groups with a solution which comprises one or more soluble salts of one or more onium ions and a salt which will prevent swelling of the membrane, for a period of time sufficient to allow the desired extent of substitution of the cations which are associated with the acid groups by onium ions.

Preferably the polymer is a fluorinated carbon polymer and more preferably the polymer is a perfluorinated polymer.

Preferably the acid groups are selected from one or more of sulfonic (—SO₃⁻), carboxylic (—CO₂⁻) or phosphonic (—PO ₃²⁻) acid groups.

Preferably the cations associated with the acid groups are selected from one or more of H⁺, Li⁺, Na⁺, K⁺, Rb⁺, Cs⁺, Fr⁺ or monovalent complex cations, for example NH₄⁺.

Within the context of the present specification the term “onium cations” includes quaternary ammonium, quaternary phosphonium, quaternary arsonium, quaternary antimonium, quaternary bismuthoniun and tertiary sulphonium cations including mixtures of one or more thereof. Such cations may be represented by the general formulae NR₄⁺, PR₄⁺, AsR₄⁺, SbR₄⁺, BiR₄⁺ and SR₃⁺ wherein R represents an organic radical.

Preferably, each R group may be independently selected from saturated or unsaturated hydrocarbon groups which comprise up to 20 carbon atoms and which may be branched or straight-chained. More preferably, each R group may be independently selected. from the group comprising C₁-C₂₀ alkyl, C₆-C₂₀ aryl and C₇-C₂₀ alkylaryl groups. Examples of suitable C₁-C₂₀ alkyl groups include methyl, ethyl, n-propyl, i-propyl, n-butyl, i-butyl, t-butyl, n-pentyl, n-hexyl, octyl and hexadecyl. Examples of suitable C₆-C₂₀ aryl groups include phenyl, biphenyl and napthyl. Examples of suitable C₇-C₂₀ alkylaryl groups include methylphenyl (or benzyl) and ethylphenyl.

Examples of suitable commercially available ammonium cation containing salts include; tricaprylylmethyl ammonium chloride (a technical mixture containing compounds with C₃-C₁₀ alkyl groups, sold under the trade names Aliquat 336™ by Fluka AG and Adogen 464™ by Aldrich Chemical Co), benzyltriethylammonium chloride (TEBA) or bromide (TEBA-Br), benzyltrimethylammonium chloride, bromide, or hydroxide (Triton BT™), tetra-n-butylammonium chloride, bromide (TBAB), iodide, hydrogen sulfate, or hydroxide, cetyltrimethylammonium bromide or chloride, benzyltributylammonium bromide or chloride, tetra-n-pentylammonium bromide or chloride, tetra-n-hexylammonium bromide or chloride, and trioctylpropylammonium bromide or chloride.

Examples of suitable commercially available phosphonium cation containing salts include; tributylhexadecylphosphonium bromide, ethyltriphenylphosphonium bromide, tetraphenylphosphonium chloride, benzyltriphenylphosphonium iodide, and tetrabutylphosphonium chloride.

Preferably the onium ions are tetra-alkylammonium ions wherein the alkyl groups present in the tetra-alkylammonium ions are each independently selected from branched or straight-chained C₁-C₂₀ alkyl groups. Even more preferably the alkyl groups present in the tetra-alkylammonium ions are each independently selected from branched or straight-chained propyl, butyl, pentyl or hexyl groups. Most preferably, the alkyl groups present in the tetra-alkylammonium ions are straight-chained butyl groups (i.e. n-butyl groups).

It will be appreciated that cation-exchange membranes exhibiting improved selectivity may be obtained even when relatively few, i.e. as little as 1%, of the cations of the acid or acid salt groups located in one or more layers of the membrane are substituted by onium ions. However, it is preferable that at least 25% of the cations of the acid or acid salt groups located in one or more layers of the membrane are substituted by onium ions. Even more preferably at least 50% of the cations of the acid or acid salt groups located in one or more layers of the membrane are substituted by onium ions.

It will also be appreciated that cation-exchange membranes exhibiting improved selectivity may be obtained over a wide range of thicknesses for the one or more layers of the membrane in which the substituted acid or acid salt groups are located. The one or more layers have a thickness less than or equal to 100% of the total membrane thickness. Thus in one embodiment the layer in which the cations of the acid groups are substituted by onium ions extends throughout the entire membrane thickness. However, it is preferable that the thickness of the one or more layers wherein the cations of the acid groups are substituted by onium ions is less than or equal to 50% of the total membrane thickness. More preferably the thickness of the one or more layers wherein the cations of the acid groups are substituted by onium ions is less than or equal to 10% of the total membrane thickness and even more preferably less than or equal to 1% of the total membrane thickness.

The one or more layers wherein the cations of the acid groups are substituted by onium ions may be located at any point throughout the thickness of the membrane. However, in a particularly preferred embodiment, the substitution of the cations of the acid or acid salt groups by onium ions is effected on one surface of the membrane and thus the membrane comprises a substituted layer which extends from one surface of the membrane inwards towards the centre of the membrane.

In another particularly preferred embodiment, the substitution of the cations of the acid or acid salt groups is effected on both surfaces of the membrane and thus the membrane comprises two substituted layers which extend from both surfaces of the membrane inwards towards the centre of the membrane.

It will be appreciated that the percentage substitution which is preferred in each of the one or more layers may depend upon the thickness of each layer. That is to say it is preferable that when the thickness of the layer is greater the percentage amount of substitution is lower whereas when the thickness of the layer is lower the percentage amount of substitution is greater. In a particularly preferred embodiment, at least 50% of the cations of the acid or acid salt groups located in one or more layers of the membrane are substituted by onium ions, wherein each of the one or more layers has a thickness less than or equal to 1% of the total membrane thickness.

When the polymer has side chains which comprise sulfonic, carboxylic or phosphonic acid groups, it may be prepared by alkaline hydrolysis of a polymer having side chains which comprise —SO₂X, —COX or —POX₂ groups where X is fluorine or chlorine. Preferably X is fluorine. In turn, the polymer having side chains which comprise —SO₂X, —COX or —POX₂ groups is preferably prepared from at least two monomers wherein one of the monomers is a fluorinated vinyl monomer and the other monomer is a fluorinated vinyl monomer which also comprises a —SO₂X, —COX or —POX₂ group.

Suitable fluorinated vinyl monomers include vinyl fluoride, hexafluoropropylene, vinylidene fluoride, trifluoroethylene, chlorotrifluoroethylene, perfluoro(alkyl vinyl ether), tetrafluoroethylene and mixtures thereof.

Suitable fluorinated vinyl monomers which also comprise a —SO₂X, —COX or —POX₂ group may be represented by the general formula CF₂═CFRSO₂X, CF₂═CFRCOX or CF₂═CFRPOX₂, wherein R is a bifunctional radical, preferably perfluorinated, comprising from 2 to 8 carbon atoms. R may be branched or unbranched and preferably comprises one or more ether linkages.

The fluorinated carbon polymer having side chains which comprise —SO₂X, —COX or —POX₂ groups may also be prepared by graft polymerisation. Monomer units which will provide the side chains may be grafted onto a fluorinated carbon polymer backbone such as polytetrafluoroethylene or polyhexafluoropropylene.

Examples of commercially available cation exchange membranes which may be modified using the process of the present invention include the Nafion™ range of materials (produced by DuPont), the Flemion™ range of materials (produced by Asahi Glass) and the Aciplex™ range of materials (produced by Asahi Chemical).

Preferably in carrying out the process of the present invention the solution used to treat the membrane is an aqueous solution. The salt which will prevent swelling of the membrane is preferably an alkali metal halide salt such as sodium bromide or sodium chloride or mixtures thereof. Prevention of swelling of the membrane enables closer control of the extent of substitution and will prevent opening of the membrane structure.

Examples of suitable negative counter-ions for the soluble onium cation salts include chloride, bromide, iodide, hydroxide and hydrogen sulfate ions.

Clearly, the period of time required for contacting the membrane with the solution will depend upon a number of factors such as the identity of the polymer and the identity and concentration of the onium ions. However a suitable time period can be readily ascertained by a skilled person carrying out routine experiments.

Similarly, suitable concentrations for the solution can be readily ascertained by a skilled person carrying out routine experiments. Preferably the solution comprises from 1 to 25% w/v of each of the one or more onium ions, more preferably from 5 to 15% w/v. Preferably the salt which is added to prevent swelling is present in the solution in a concentration of from 1 to 10M, more preferably from 2 to 6M.

The presence of the salt is to prevent swelling of the membrane during the treatment process and thus avoids the requirement for a subsequent heat treatment of the membrane. The concentration of the salt is chosen so that the state of hydration of the membrane is similar to that which will prevail in the electrochemical cell in which it is used, thus minimizing dimensional changes.

Membranes manufactured according to the present invention may be used in a variety of electrochemical systems. In particular, they may be used as cation exchange membranes in chloro-alkali cells or in regenerative fuel cells (RFCs) such as those described in U.S. Pat. No. 4,485,154. U.S. Pat. No. 4,485,154 discloses an electrically chargeable, anionically active, reduction-oxidation system using a sulfide/polysulfide reaction in one half of the cell and an iodine/iodide, chlorine/chloride or bromine/bromide reaction in the other half of the cell.

The overall chemical reaction involved, for example, for the bromine/bromide-sulfide/polysulfide system is shown in Equation 1 below:

Br₂+S₂⁻ [symbol] 2Br⁻+S Equation 1

However, within an RFC such as that described in U.S. Pat. No. 4,485,154, the reaction takes place in separate but dependent bromine and sulfur half-cell reactions as shown below in Equations 2 and 3:

Br₂+2e⁻ [symbol] 2Br⁻ Equation 2

S²⁻ [symbol] 2e⁻+S Equation 3

The sulfur produced in Equations 1 and 3 forms soluble polysulfide species (e.g. S₂²⁻, S₃²⁻, S₄²⁻ and S₅²⁻) in the presence of sulfide ions.

When the RFC is discharging, bromine is converted to bromide on the +ve side of the membrane and sulfide is converted to polysulfide on the −ve side of the membrane. Equation 1 goes from left to right and metal ions flow from the −ve side of the membrane to the +ve side of the membrane to complete the circuit. When the RFC is charging, bromide is converted to bromine on the +ve side of the membrane and polysulfide is converted to sulfide on the −ve side of the membrane.

Equation 1 goes from right to left and metal ions flow from the +ve side of the membrane to the —ve side of the membrane to complete the circuit. The metal ions used are preferably alkali metal ions such as Na⁺ or K⁺. Salts of alkali metals are particularly suitable because they generally exhibit good solubility in aqueous solution.

In the case of a halogen/halide-sulfide/polysulfide RFC such as that described above, one of the most important factors which reduces the electrolyte lifetime is the diffusion of unwanted species across the membrane. Although a cation selective ion-exchange membrane is used, during extended cycling of the cell some anionic species diffuse through the membrane. Thus, in the case of a bromine/bromide-sulfide/polysulfide RFC, sulfide ions diffuse through the membrane from the sulfide/polysulfide electrolyte into the bromine/bromide electrolyte where they will be oxidised by the bromine to form sulfate ions as shown in equation 4 below:

HS⁻+4Br₂+4H₂O→8Br⁻+SO₄²⁻+9H⁺ Equation 4

The oxidation of the sulfide goes beyond that which occurs during normal operation of the RFC. That is to say, the sulfide ions are oxidised all the way to sulfate ions and consequently consume four bromine molecules per sulfide ion rather than the normal one bromine molecule per sulfide ion which is consumed in the reaction scheme of Equation 1. As a result, the bromine/bromide electrolyte becomes discharged to a greater extent than the sulfide/polysulfide electrolyte. Thus, the electrolytes become unbalanced and when the cell is discharging there is insufficient bromine present to complete the discharge cycle. As a result, the voltage generated by the cell begins to decline earlier in the discharge cycle than when the electrolytes are balanced, i.e. the discharge cycle is shorter than the charge cycle. In order to compensate for the unbalancing effect of sulfide diffusion through the membrane, some kind of rebalancing process is generally necessary. In the context of the present specification, when the term “balanced” is used to describe the electrolytes it means that the concentrations of the reactive species within the electrolytes are such that both half-cell reactions are able to progress substantially to completion without one reaching completion before the other. Similarly, in the context of the present specification, the term “rebalancing” refers to a process which alters the concentration of one or more reactive species in one or both of the electrolytes so as to return said electrolytes to a balanced state or so as to maintain said electrolytes in a balanced state. Another disadvantageous result of sulfide crossover is the accumulation of sulfate ions in the bromine/bromide electrolyte. When a certain concentration of sulfate ions is reached, sulfate salts may begin to precipitate out of the bromine/bromide electrolyte. The presence of such precipitates is undesirable since it may cause scaling within the apparatus, blockage of electrolyte ducts and contamination of the electrodes and/or membranes. Therefore some kind of process for removal of sulfate ions is generally necessary.

It has been found that when membranes according to the present invention are used in an RFC such as that described above, the diffusion of sulfide ions across the membrane is reduced. This reduces the build-up of sulfate ions and reduces the need for rebalancing the cell. Furthermore, despite this improvement in selectivity, the membrane does not cause any significant increase in the resistivity of the cell. A further surprising advantage of the membrane of the present invention is that it is found to be more resistant to the precipitation of sulfur within the membrane.

The present invention also includes within its scope an electrochemical apparatus which comprises a cation exchange membrane produced according to the process of the present invention.

Preferably the electrochemical apparatus comprises a single cell or an array of cells, each cell with a chamber (+ve chamber) containing a +ve electrode and an electrolyte and a chamber containing a —ve electrode and an electrolyte, the said +ve chamber(s) and —ve chamber(s) being separated from one another by a cation exchange membrane of the present invention.

The present invention will be further described with reference to the following non-limiting examples and the accompanying figures, in which:

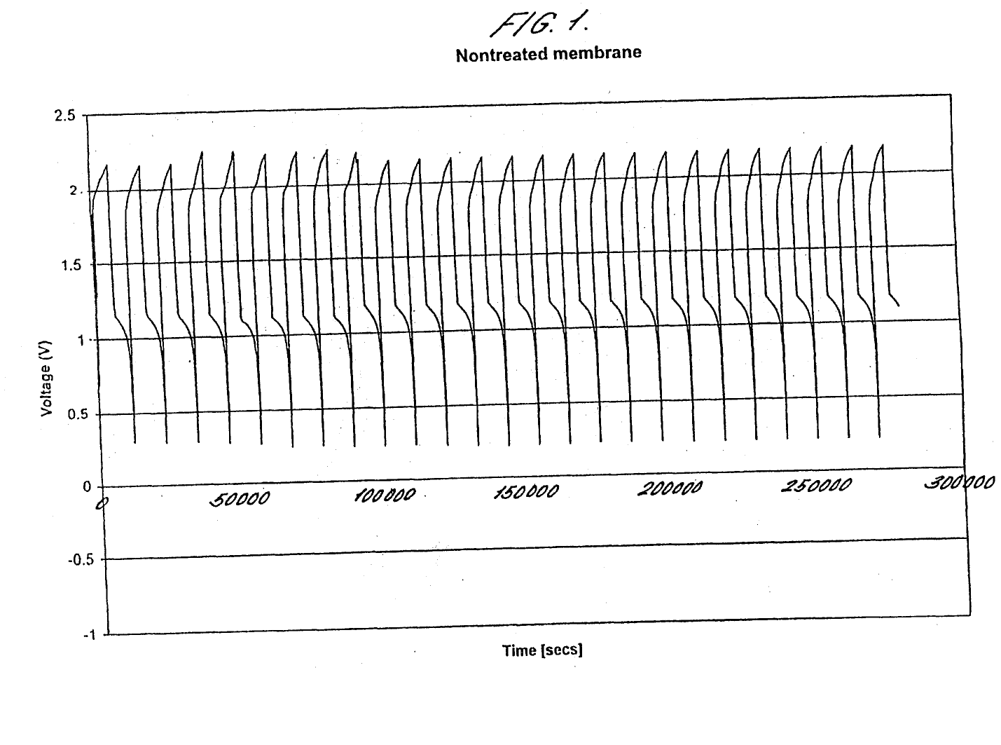

FIG. 1 is a plot of voltage versus time for the cell of comparative example 1.

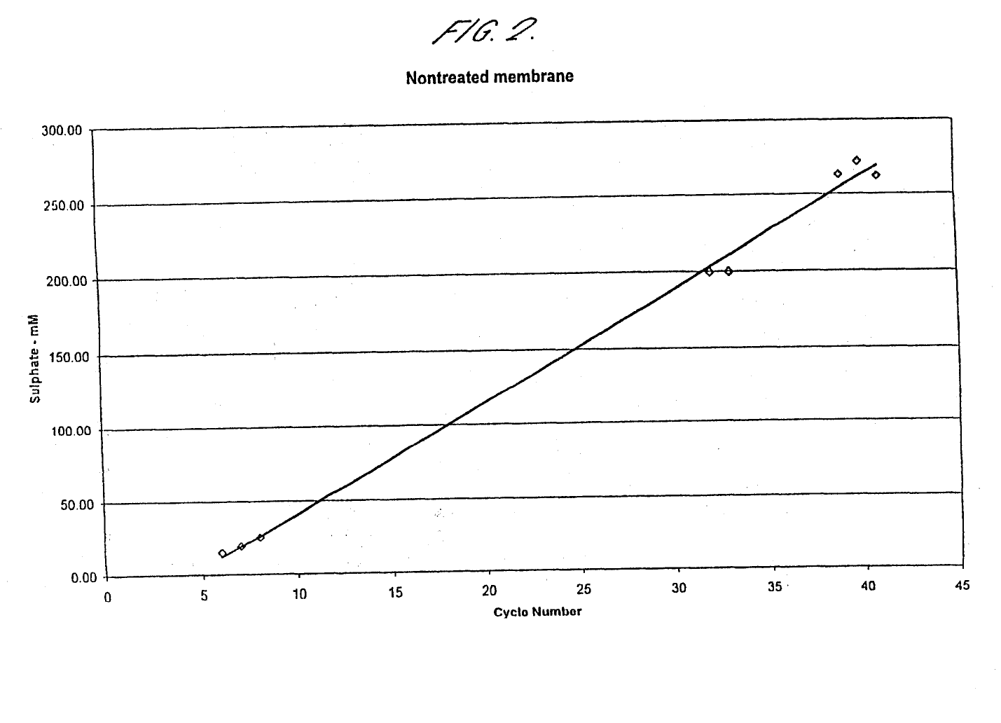

FIG. 2 is a plot of the build up of sulfate ions in the bromine/bromide electrolyte of comparative example 1.

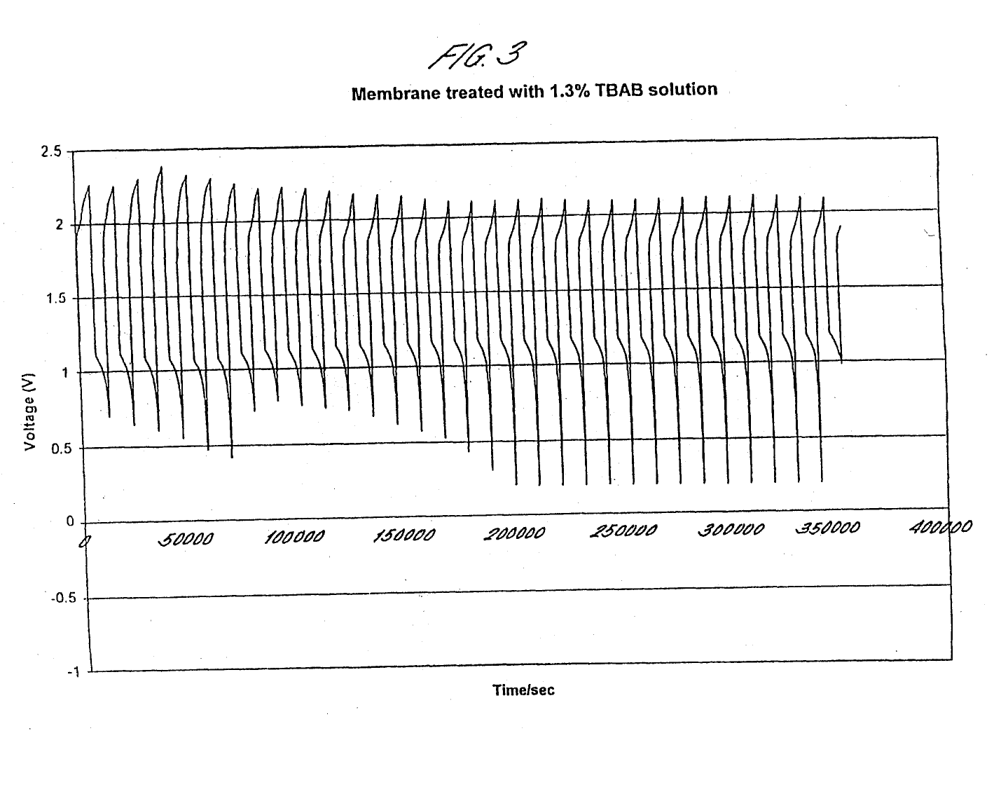

FIG. 3 is a plot of voltage versus time for the cell of example 2.

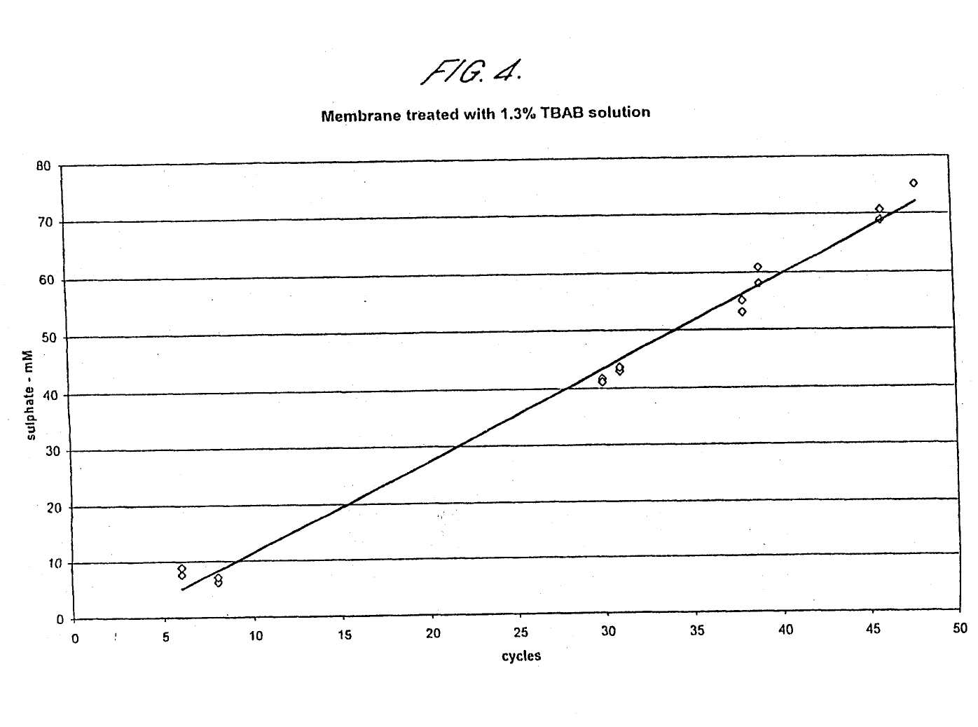

FIG. 4 is a plot of the build up of sulfate ions in the bromine/bromide electrolyte of example 2.

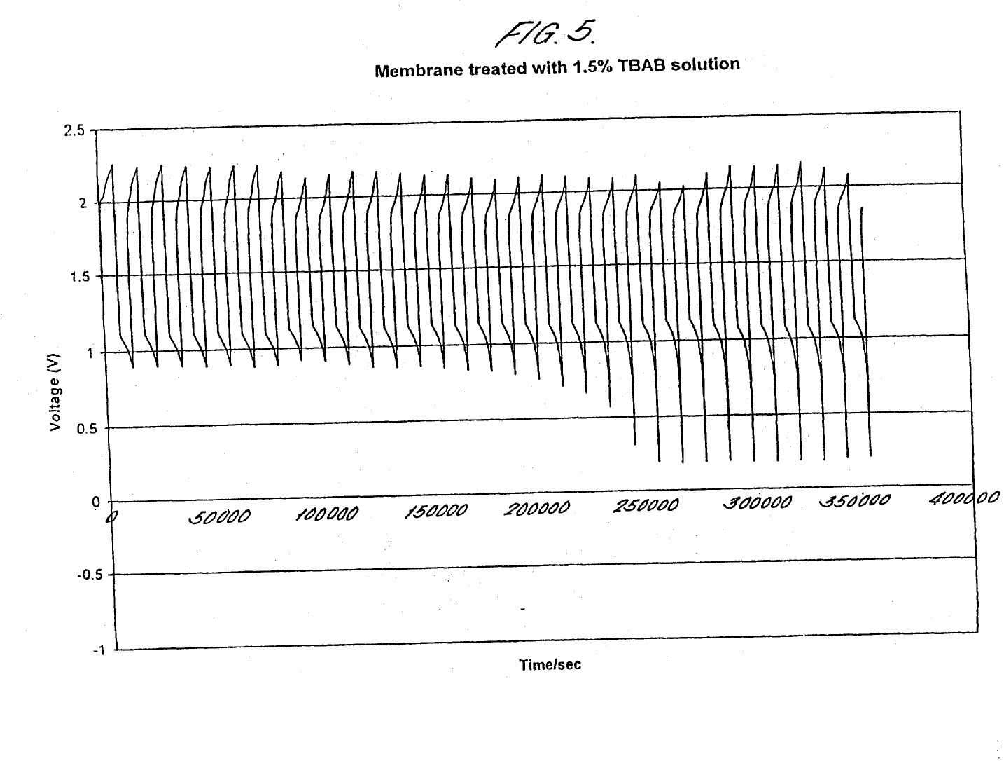

FIG. 5 is a plot of voltage versus time for the cell of example 3.

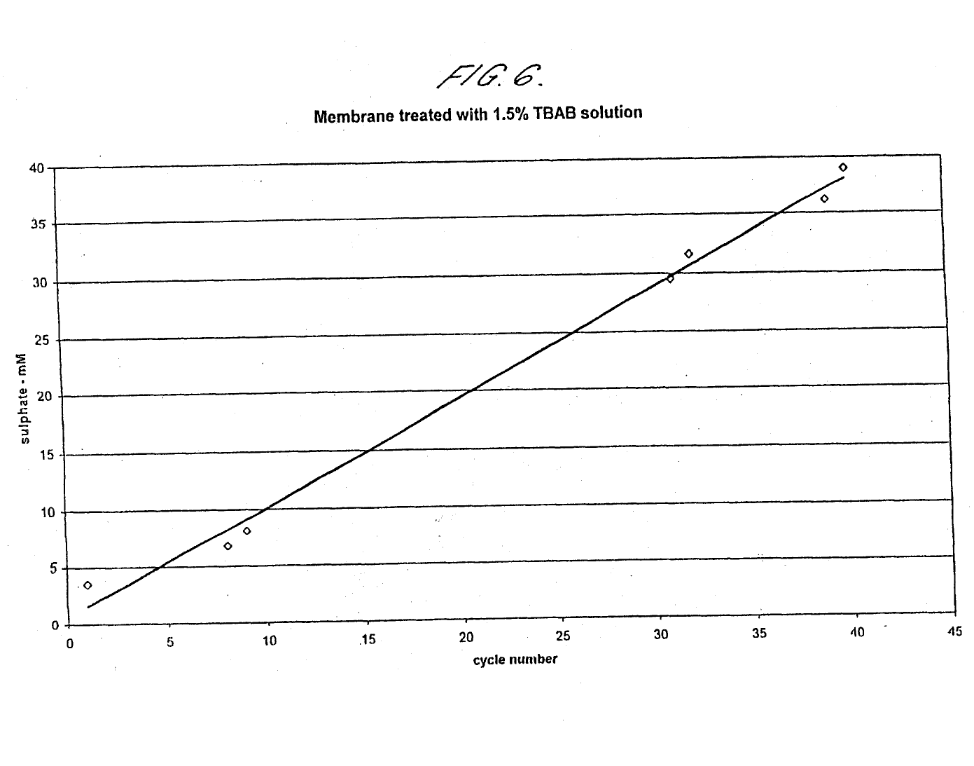

FIG. 6 is a plot of the build up of sulfate ions in the bromine/bromide electrolyte of example 3.

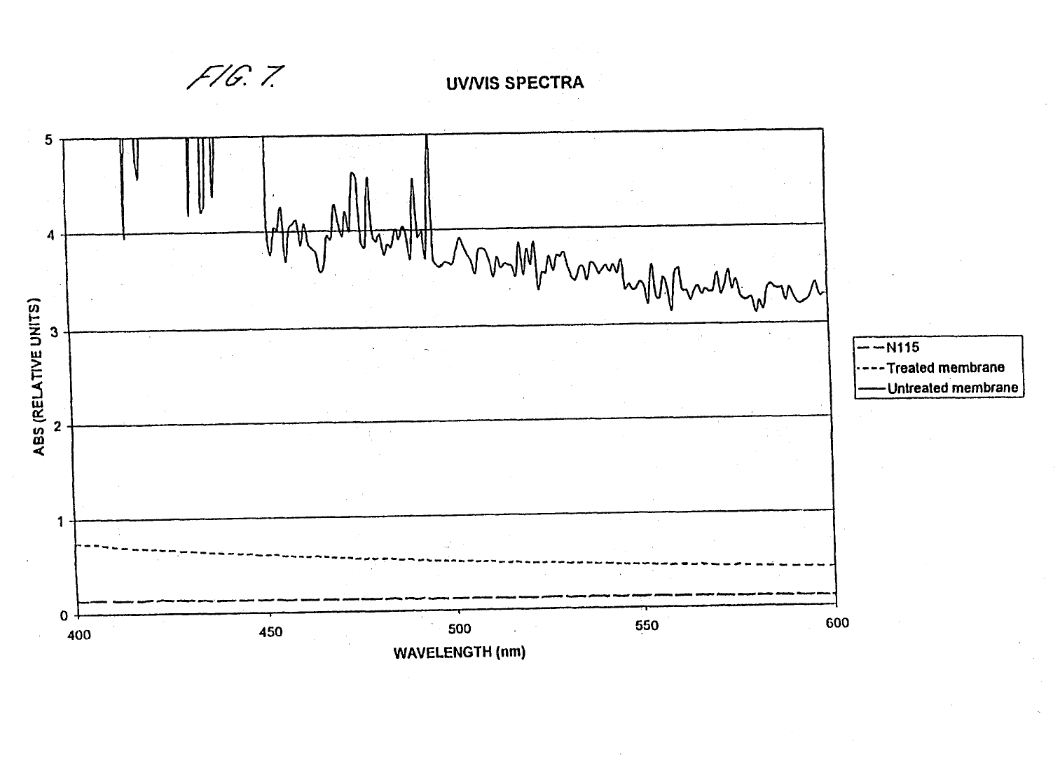

FIG. 7 is a plot of absorbance versus wavelength for the membranes of comparative example 1 and example 2 and for an unused Nafion 115T™ membrane.

### COMPARATIVE EXAMPLE 1

A regenerative fuel cell having aqueous sulfide/polysulfide and aqueous bromine/bromide electrolytes was set up. The cell apparatus had the following specifications:

| | |
|---|---|
| electrode material | polyethylene impregnated |
| | with carbon |
| electrode area | 174 cm² |
| membrane material | Nafion ™ 115 |
| membrane-electrode gap | 1 mm |

The electrolyte provided for circulation through the negative half of the cell was initially made up of:

| | |
|---|---|
| Na₂S_{3,7} | 1.3 M |
| NaOH | 1 M |
| NaBr | 1 M |

The electrolyte provided for circulation through the positive half of the cell was initially made up of:

| | |
|---|---|
| NaBr | 5 M |

The total volume of each electrolyte was 300 ml.

After an initial charging period, the cell was subjected to successive charge/discharge cycles-. The operating conditions of-the cell were as follows:

| | |
|---|---|
| current density | 60 mA/cm² |
| cycle time | 3 hours (i.e. 1.5 hours |
| | charge and 1.5 hours |
| | discharge) |
| flow rate | 2 litres/min |

FIG. 1 shows a plot of the voltage of the cell over a number of cycles.

The build-up of sulphate in the bromine/bromide electrolyte was monitored over about 45 cycles by ion chromatography. FIG. 2 shows a plot of the increase in sulphate build-up in the bromine/bromide electrolyte versus the cycle number. It was found that the average sulphate build-up was 7.3 mM/cycle.

### EXAMPLE 2

A regenerative fuel cell having aqueous sulfide/polysulfide and aqueous bromine/bromide electrolytes was set up the same as for the comparative example described above.

Prior to adding the electrolytes to the cell, a 1.3% w/v solution of tetrabutylammonium bromide (TBAB) in 5M NaBr was circulated through the negative half of the cell for 14 hours.

After an initial charging period, the cell was subjected to successive charge/discharge cycles. The operating conditions of the cell were the same as for the comparative example described above.

FIG. 3 shows a plot of the voltage of the cell over a number of cycles. It can be seen that, with-the exception of the 5th and 6th cycles, the voltage of the cell during discharge remains above 0.5 for the all of the first 15 discharge cycles. It is only after 15 discharge cycles that the voltage of the cell during discharge consistently drops below 0.5 V. This should be compared with FIG. 1 where the voltage of the cell during discharge drops below 0.5 from the first cycle. The drop-off in voltage in the comparative example results from the diffusion of sulfide and polysulfide species across the membrane which causes the electrolytes to become unbalanced. In example 1 the diffusion of sulfide and polysulfide species across the membrane is reduced and accordingly the tendency for the electrolytes to become unbalanced is also reduced.

The build-up of sulphate in the bromine/bromide electrolyte was monitored over about 45 cycles by ion chromatography. FIG. 4 shows a plot of the increase in sulphate build-up in the bromine/bromide electrolyte versus the cycle number. It was found that the average sulphate build-up was 1.6 mM/cycle.

### Example 3

A regenerative fuel cell having aqueous sulfide/polysulfide and aqueous bromine/bromide electrolytes was set up the same as for the comparative example described above.

Prior to adding the electrolytes to the cell, a 1.5% w/v solution of TBAB in 5M NaBr was circulated through the negative half of the cell for 14 hours.

After an initial charging period, the cell was subjected to successive charge/discharge cycles. The operating conditions of the cell were the same as for the comparative example described above.

FIG. 5 shows a plot of the voltage of the cell over a number of cycles. It can be seen that the voltage of the cell during discharge remains above 0.5 for the first 21 discharge cycles. It is only after 21 discharge cycles that the voltage of the cell during discharge consistently drops below 0.5 V. This should be compared with FIG. 1 where the voltage of the cell during discharge drops below 0.5 from the first cycle. The drop-off in voltage in the comparative example results from the diffusion of sulfide and polysulfide species across the membrane which causes the electrolytes to become unbalanced. In example 2 the diffusion of sulfide and polysulfide species across the membrane is reduced and accordingly the tendency for the electrolytes to become unbalanced is also reduced.

The build-up of sulphate in the bromine/bromide electrolyte was monitored over about 45 cycles by ion chromatography. FIG. 6 shows a plot of the increase in sulphate build-up in the bromine/bromide electrolyte versus the cycle number. It was found that the average sulphate build-up was 0.9 mM/cycle.

The examples above demonstrate that when cation exchange membranes according to the present invention are used in a regenerative fuel cell having aqueous sulfide/polysulfide and aqueous bromine/bromide electrolytes, they exhibit improved selectivity for alkali metals ions with a reduction in the unwanted diffusion of sulfide ions through the membrane. Furthermore, they do not cause any decrease in the voltage efficiency of the cell.

It has also surprisingly been discovered that the membranes of the present invention are much more resistant to precipitation of sulfur within the membrane. This effect is illustrated by FIG. 7 which shows the UV/VIS spectra for the membranes of comparative example 1 (Untreated membrane) and example 1 (Treated membrane) after their use in both cells.

For comparison, it also shows the UV/VIS spectrum of a Nafion™ 115 membrane (N115) before use in a cell of the type described in the examples. It can be seen that the untreated membrane exhibits a much stronger absorbance due to the presence of sulfur in the membrane. This effect is also observable visually. The untreated membrane is opaque when removed from the cell whereas the treated membrane remains transparent.

1. A process for manufacturing a cation-selective ion exchange membrane which comprises contacting one or both sides of a membrane comprising a polymer having side chains which contain acid or acid salt groups with a solution which comprises one or more soluble salts of one or more onium ions and a salt which will prevent swelling of the membrane, for a period of time sufficient to allow the desired extent of substitution of the cations which are associated with the acid groups by onium ions.

2. A process as claimed in claim 1 wherein the polymer is a fluorinated carbon polymer having side chains which comprise sulfonic, carboxylic or phosphonic acid groups.

3. A process as claimed in claim 1 or claim 2 wherein the onium cations are selected from one or more of NR₄⁺, PR₄⁺, AsR₄⁺, SbR₄⁺, BiR₄⁺ and SR₃⁺ wherein R is an organic radical.

4. A process as claimed in claim 3 wherein each R group may be independently selected from saturated or unsaturated hydrocarbon groups which comprise up to 20 carbon atoms and which may be branched or straight-chained.

5. A process as claimed in claim 3 or claim 4 wherein each R group is independently selected from the group comprising C₁-C₂₀ alkyl, C₆-C₂₀ aryl and C₇-C₂₀ alkylaryl groups.

6. A process as claimed in any one of the preceding claims wherein the onium ions are tetra-alkylammonium ions wherein the alkyl groups present in the tetra-alkylammonium ions are each independently selected from branched or straight-chained C₁-C₂₀ alkyl groups.

7. A process as claimed in claim 6 wherein the alkyl groups present in the tetra-alkylammonium ions are each independently selected from branched or straight-chained propyl, butyl, pentyl or hexyl groups.

8. A process as claimed in claim 6 wherein the alkyl groups present in the tetra-alkylammonium ions are straight-chained butyl groups.

9. A process as claimed in any one of the preceding claims wherein at least 25% of the cations of the acid or acid salt groups located in the one or more layers of the membrane are substituted by onium ions.

10. A process as claimed in any one of the preceding claims wherein at least 50% of the cations of the acid or acid salt groups located in the one-or more layers of the membrane are substituted by onium ions.

11. A process as claimed in any one of the preceding claims wherein the thickness of the one or more layers wherein the cations of the acid or acid salt groups are substituted by onium ions is less than or equal to 50% of the total membrane thickness.

12. A process as claimed in any one of the preceding claims wherein the thickness of the one or more layers wherein the cations of the acid or acid salt groups are substituted by onium ions is less than or equal to 10% of the total membrane thickness.

13. A process as claimed in any one of the preceding claims wherein the thickness of the one or more layers wherein the cations of the acid or acid salt groups are substituted by onium ions is less than or equal to 1% of the total membrane thickness.

14. A process as claimed in any one of the preceding claims wherein substitution of the cations of the acid or acid salt groups is effected on one surface of the membrane such that the layer in which the substituted acid or acid salt groups are located extends from one surface of the membrane inwards towards the centre of the membrane.

15. A process as claimed in any one of the preceding claims wherein substitution of the cations of the acid or acid salt groups is effected on both-surfaces of the membrane such that the layers in which the substituted acid or acid salt groups are located extend from both surfaces of the membrane inwards towards the centre of the membrane.

16. A process as claimed in any one of the preceding claims wherein the polymer having side chains which comprise acid or acid salt groups is prepared by alkaline hydrolysis of a polymer having side chains which comprise —SO₂X, —COX or —POX₂ groups where X is fluorine or chlorine.

17. A process as claimed in claim 16 wherein the polymer having side chains which comprise —SO₂X, —COX or —POX₂ groups is prepared from at least two monomers wherein one of the monomers is a fluorinated vinyl monomer and the other monomer is a fluorinated vinyl monomer which also comprises a —SO₂X, —COX or —POX₂ group.

18. A process as claimed in any one of the preceding claims wherein the polymer having side chains which comprise acid or acid salt groups is-a perfluorinated carbon polymer with perfluorinated side-chains.

19. A process as claimed in any one of the preceding claims wherein the polymer having side chains which comprise acid or acid salt groups is prepared by a process which comprises a graft polymerisation step.

20. A process as claimed in any one of the preceding claims wherein the salt which will prevent swelling of the membrane is sodium bromide, sodium chloride or mixtures thereof.

21. A process as claimed in any one of the preceding claims wherein the solution comprises from 1 to 25% w/v of each of one or more onium ions.

22. A process as claimed in any one of the preceding claims wherein the salt is added to the solution in a concentration of from 1 to 10M.

23. A process as claimed in claim 22 wherein the salt is added to the solution in a concentration of from 2 to 6M.

24. A process as claimed in any one of the preceding claims wherein the membrane is contacted with the solution comprising one or more soluble salts of one or more onium ions and a salt which will prevent swelling of the membrane in an electrochemical process in which the membrane is to be used.

25. A process as claimed in any one of the preceding claims wherein the concentration of the salt is chosen so that the state of hydration of the membrane during the treatment process is substantially the same as the state of hydration of the membrane in the electrochemical process in which it is to be used.
